(19) United States
(12) Patent Application Publication
(10) Pub. No.: US 2010/0003451 A1
(43) Pub. Date: Jan. 7, 2010

(54) Diamond membrane and its preparation

(75) Inventor: Benny Kuo, Taichung (TW)

Correspondence Address: BACON & THOMAS, PLLC, 625 SLATERS LANE, FOURTH FLOOR, ALEXANDRIA, VA, 22314-1176, US

(73) Assignee: SING RAY CORPORATION, TAICHUNG (TW)

(21) Appl. No.: 12/458,056

(22) Filed: Jun. 30, 2009

(30) Foreign Application Priority Data
Jul. 4, 2008 (TW) 97211972

(51) Int. Cl. B32B 5/30; B32B 37/24

(52) U.S. Cl. 428/105; 156/276

(57) ABSTRACT

A diamond membrane includes a substrate having a substrate surface and defining a normal line perpendicular to the substrate surface, a first bonding layer formed on the substrate surface of the substrate with the major axes of the bonding crystals thereof extending at an angle within 0˜45-degrees relative to the normal line, diamond grains evenly distributed over the exposed outer surface of the first bonding layer to force gaps among the bonding crystals of the first bonding layer sideways for enabling the diamond grains to be partially engaged into the first bonding layer and partially protruding over the exposed outer surface of the first bonding layer, and a second bonding layer formed on the surface of the first bonding layer and the periphery of the diamond grains with the major axes of the bonding crystals thereof extending at an angle within 45˜90-degrees to let the diamond grains partially protrude over the second bonding layer.

### BACKGROUND OF THE INVENTION

1. Field of the Invention

The present invention relates to diamond membranes and more particularly, to the structure of a diamond membrane and its preparation.

2. Description of the Related Art

A diamond membrane is made by means of forming a bonding layer by means of adhesion, electroplating or any other forming techniques, and then affixing diamond grains to the bonding layer.

When an electroplating technique is employed to form a bonding layer on a substrate for the bonding of diamond grains, the bonding power between the bonding layer and the substrate is not excellent, resulting in poor fixation of the diamond grains. Accordingly, an improvement is this regards is necessary.

### SUMMARY OF THE INVENTION

The present invention has been accomplished under the circumstances in view. It is the main object of the present invention to provide a diamond membrane and its preparation that effectively enhances the bonding between the bonding layer and the substrate.

It is another object of the present invention to provide a diamond membrane and its preparation that enhances fixation of diamond grains to the bonding layer.

To achieve these and other objects of the present invention, a diamond membrane comprises a substrate having a substrate surface and defining a normal line perpendicular to the substrate surface, a first bonding layer formed on the substrate surface of the substrate with the major axes of the bonding crystals thereof extending at an angle within 0˜45-degrees relative to the normal line, diamond grains evenly distributed over the exposed outer surface of the first bonding layer to force gaps among the bonding crystals of the first bonding layer sideways for enabling the diamond grains to be partially engaged into the first bonding layer and partially protruding over the exposed outer surface of the first bonding layer, and a second bonding layer formed on the surface of the first bonding layer and the periphery of the diamond grains with the major axes of the bonding crystals thereof extending at an angle within 45˜90-degrees to let the diamond grains partially protrude over the second bonding layer.

To achieve these and other objects of the present invention, the diamond membrane preparation method includes the steps of: a) providing a substrate having a substrate surface and defining a normal line perpendicular to the substrate surface; b) bonding first bonding crystals to the substrate surface of the substrate in the form of a narrow elongated strip to form a first bonding layer on the substrate surface of the substrate to have the major axis of the first bonding crystal of the first bonding layer be controlled at an angle within 0°˜45° relative to the normal line, so that a gap is defined between each two adjacent first bonding crystals; c) evenly spreading diamond grains on the exposed outer surface of the first bonding layer to impart a pressure to the first bonding layer that forces the gaps among the first bonding crystals sideways for enabling the diamond grains to be partially engaged into the first bonding layer and partially protruding over the outer surface of the first bonding layer subject to a predetermined range; and d) bonding second bonding crystals to the outer surface of the first bonding layer and the periphery of the diamond grains to form a second bonding layer on the outer surface of the first bonding layer and a part of the surfaces of the diamond grains that protrude over the first bonding layer, and to let the diamond grains protrude over the second bonding layer at a predetermined range.

### BRIEF DESCRIPTION OF THE DRAWINGS

FIG. 1 is a sectional view of a diamond membrane in accordance with the present invention.

FIG. 2 is a schematic sectional view of the present invention, showing the formation of the first bonding layer on the surface of the substrate.

FIG. 3 is a schematic sectional view of the present invention, showing diamond grains evenly distributed over the first bonding layer.

### DETAILED DESCRIPTION OF THE INVENTION

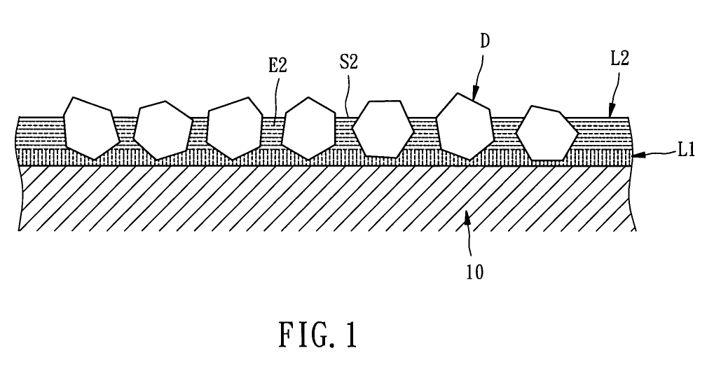

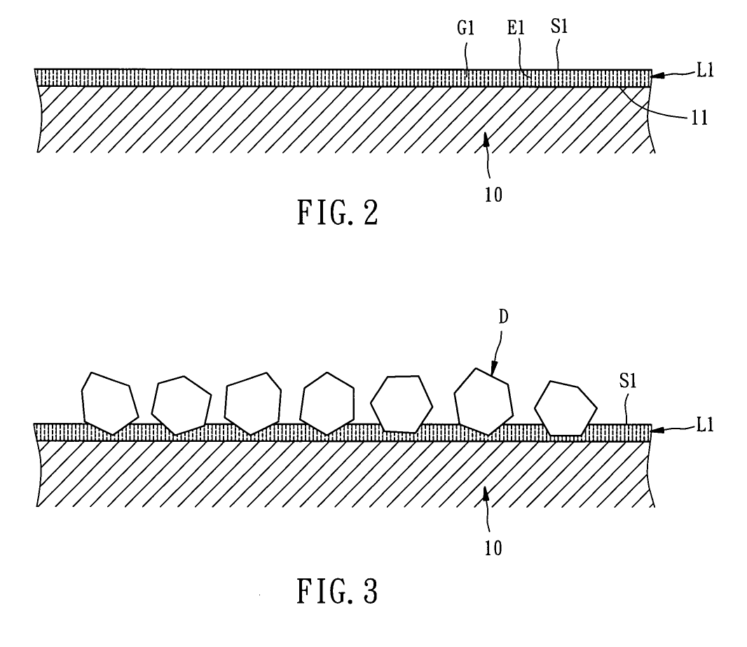

Referring to FIGS. 1˜3, a diamond membrane is shown for use in a tool, such as screwdriver, wrench, drill, cutter, abrasive disk or the like, or any of a variety of other objects that does not pertain to the filed of tools.

The preparation of the diamond membrane includes the steps of:

a) providing a substrate 10 having a surface 11 and defining a normal line that is perpendicular to the surface 11;

b) bonding first bonding crystals E1 to the surface 11 of the substrate 10 in the form of a narrow elongated strip to form a first bonding layer L1 on the surface 11 of the substrate 10, wherein the first bonding crystals E1 may be kept in parallel or intersected with one another; the first bonding crystals E1 are formed of nickel, cobalt, copper, tin solder, gold, palladium, tin or silver, by means of an electroplating technique; a static treatment is employed during the electroplating process to control the direction of the major axis of each first bonding crystal E1 of the first bonding layer L1 at a predetermined angle within 0°˜45°, or preferably at zero degree relative to the aforesaid normal line, i.e., to be perpendicular to the surface 11, so that gaps G1 are defined among the first bonding crystals E1;

c) evenly spreading diamond grains D on the exposed outer surface S1 of the first bonding layer L1 to impart a pressure to the first bonding layer L1 that forces the gaps G1 sideways, enabling the diamond grains D to be partially engaged into the first bonding layer L1 and partially protruding over the outer surface S1 of the first bonding layer L1 subject to a predetermined range; and

d) bonding second bonding crystals E2 to the outer surface S1 of the first bonding layer L1 and the periphery of the diamond grains D to form a second bonding layer L2 on the outer surface S1 of the first bonding layer L1 and a part of the periphery of the diamond grains D, for enabling the diamond grains D to protrude over the second bonding layer L2 at a predetermined range, wherein the second bonding crystals E2 may be kept in parallel or intersected with one another; the second bonding crystals E2 are formed of nickel, cobalt, copper, tin solder, gold, palladium, tin or silver, by means of an electroplating technique; a static treatment is employed during the electroplating process to control the direction of the major axis of the second bonding crystal E2 of the second bonding layer L2 at a predetermined angle within 45°˜90°, or preferably, at 90 degrees relative to the aforesaid normal line, i.e., to be in parallel to the surface 11, so that gaps G1 are defined among the bonding crystals E1.

Based on the aforesaid preparation, the invention has the following features and benefits:

At first, the diamond membrane made according to the present invention has the mechanical characteristics of high hardness, low friction coefficient and high stability, therefore the diamond membrane has the nature of wear resistance and effectively improves processing precision.

Further, according to conventional techniques, a surface treatment layer of high bonding power must be formed on the surface of the tool to facilitate bonding of the second bonding layer before coating the surface of the tool with a coating layer. The invention allows direct bonding of the second bonding layer L2 without preparation of the surface treatment layer, more particularly, when a non-conductive target material is used, the bonding power will be much higher than the pre-processed deposition layer. Further, the invention has the benefit of formation step simplification.

Because the major axis of the bonding crystals E1 of the first bonding layer L1 extends at an angle within 0°˜45° relative to the normal line, pressing down the diamond grains D and the second bonding layer L2 compacts the bonding crystals E1 of the first bonding layer L1 and enhances the positioning of the diamond grains D.

In an alternate form of the present invention, the major axis of the bonding crystals E1 of the first bonding layer L1 can extend at an angle within 45°˜90° relative to the normal line, and the major axis of the second bonding crystal E2 of the second bonding layer L2 can extend at and angle within 0°˜45° relative to the normal line.

Further, a third bonding layer (not shown) may be formed on the bonding crystals E1 of the first bonding layer L1 where the major axis of the bonding crystals (not shown) of this third bonding layer extends at an angle within 0°˜45° relative to the normal line. After formation of the third bonding layer on the bonding crystals E1 of the first bonding layer L1, the bonding crystals E2 of the second bonding layer L2 is then formed on the bonding crystals of the third bonding layer.

In other words, in each two adjacent bonding layers, the major axis of the bonding crystal of one bonding layer extends at and angle within 0°˜45° relative to the normal line while the major axis of the bonding crystal of the other bonding layer extends at and angle within 45°˜90° relative to the normal line.

Thus, when compared to the conventional diamond membrane formation method, the invention eliminates the drawbacks of rough coating surface and low coating bonding power and improves the mechanical properties of the tool. Therefore, a tool made according to the present invention has high stability and long work life characteristics.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A diamond membrane comprising:
a substrate having a substrate surface and defining a normal line perpendicular to said substrate surface;
a first bonding layer formed of bonding crystals on said substrate surface of said substrate, the bonding crystals of said first bonding layer each having a major axis that extends at an angle within 0°˜45° relative to said normal line;
a plurality of diamond grains evenly distributed over an exposed outer surface of said first bonding layer to force gaps among the bonding crystals of said first bonding layer sideways for enabling said diamond grains to be partially engaged into said first bonding layer and partially protruding over the exposed outer surface of said first bonding layer; and
a second bonding layer formed on the exposed outer surface of said first bonding layer, said second bonding layer having bonding crystals bonded to said first bonding layer and the periphery of said diamond grains for enabling said diamond grains to partially protrude over said second bonding layer at a predetermined range, the bonding crystals of said second bonding layer each extending at an angle within 45°˜90° relative to said normal line.

2. The diamond membrane as claimed in claim 1, further comprising a third bonding layer having bonding crystals sandwiched between said first bonding layer and said second bonding layer, the bonding crystals of said third bonding layer each extending at an angle within 0°˜90° relative to said normal line.

3. The diamond membrane as claimed in claim 1, wherein the extending direction of the major axis of the bonding crystals of said first bonding layer is controlled at the desired angle by means of a static treatment or chemical catalysis during formation of said first bonding layer; the extending direction of the major axis of the bonding crystals of said second bonding layer is controlled at the desired angle by means of a static treatment or chemical catalysis during formation of said second bonding layer.

4. The diamond membrane as claimed in claim 1, wherein the major axes of the bonding crystals of said first bonding layer are arranged in parallel or intersected with one another.

5. The diamond membrane as claimed in claim 1, wherein the major axes of the bonding crystals of said second bonding layer are arranged in parallel or intersected with one another.

6. A diamond membrane preparation method, comprising the steps of:
a) providing a substrate having a substrate surface and defining a normal line perpendicular to said substrate surface;
b) bonding first bonding crystals to said substrate surface of said substrate in the form of a narrow elongated strip to form a first bonding layer on said substrate surface of said substrate to have the major axis of the first bonding crystal of said first bonding layer be controlled at an angle within 0°˜45° relative to said normal line, so that a gap is defined between each two adjacent first bonding crystals;
c) evenly spreading diamond grains on the exposed outer surface of said first bonding layer to impart a pressure to said first bonding layer that forces the gaps among said first bonding crystals sideways for enabling said diamond grains to be partially engaged into said first bonding layer and partially protruding over the outer surface of said first bonding layer subject to a predetermined range; and
d) bonding second bonding crystals to the outer surface of said first bonding layer and the periphery of said diamond grains to form a second bonding layer on the outer surface of said first bonding layer and a part of the surfaces of the diamond grains that protrude over said first bonding layer, and to let said diamond grains protrude over said second bonding layer at a predetermined range.

7. The diamond membrane preparation method as claimed in claim 6, wherein a static treatment is employed during step b) to have the major axis of the first bonding crystal of said first bonding layer be controlled at an angle within 0°˜45° relative to said normal line.

8. The diamond membrane preparation method as claimed in claim 6, wherein a chemical catalysis is employed during step b) to have the major axis of the first bonding crystal of said first bonding layer be controlled at an angle within 0°˜45° relative to said normal line.

9. The diamond membrane preparation method as claimed in claim 6, wherein the major axes of the bonding crystals of said first bonding layer are arranged in parallel during step b).

10. The diamond membrane preparation method as claimed in claim 6, wherein the major axes of the bonding crystals of said first bonding layer are intersected with one another during step b).

11. The diamond membrane preparation method as claimed in claim 6, wherein a static treatment is employed during step d) to have the major axis of the second bonding crystal of said second bonding layer be controlled at a predetermined angle relative to said normal line.

12. The diamond membrane preparation method as claimed in claim 6, wherein the major axes of the bonding crystals of said second bonding layer are controlled at an angle within 45°˜90° relative to said normal line during step d).

13. The diamond membrane preparation method as claimed in claim 6, wherein the major axes of the bonding crystals of said second bonding layer are arranged in parallel during step b).

14. The diamond membrane preparation method as claimed in claim 6, wherein the major axes of the bonding crystals of said second bonding layer are intersected with one another during step b).

15. A diamond membrane comprising:
a substrate having a substrate surface and defining a normal line perpendicular to said substrate surface;
a first bonding layer formed of bonding crystals on said substrate surface of said substrate, the bonding crystals of said first bonding layer each having a major axis that extends at an angle within 45°˜90° relative to said normal line;
a plurality of diamond grains evenly distributed over an exposed outer surface of said first bonding layer to force gaps among the bonding crystals of said first bonding layer sideways for enabling said diamond grains to be partially engaged into said first bonding layer and partially protruding over the exposed outer surface of said first bonding layer; and
a second bonding layer formed on the exposed outer surface of said first bonding layer, said second bonding layer having bonding crystals bonded to said first bonding layer and the periphery of said diamond grains for enabling said diamond grains to partially protrude over said second bonding layer at a predetermined range, the bonding crystals of said second bonding layer each extending at an angle within 0°˜45° relative to said normal line.

16. The diamond membrane as claimed in claim 15, further comprising a third bonding layer having bonding crystals sandwiched between said first bonding layer and said second bonding layer, the bonding crystals of said third bonding layer each extending at an angle within 0°˜90° relative to said normal line.

17. The diamond membrane as claimed in claim 15, wherein the extending direction of the major axis of the bonding crystals of said first bonding layer is controlled at the desired angle by means of a static treatment or chemical catalysis during formation of said first bonding layer; the extending direction of the major axis of the bonding crystals of said second bonding layer is controlled at the desired angle by means of a static treatment or chemical catalysis during formation of said second bonding layer.

18. The diamond membrane as claimed in claim 15, wherein the major axes of the bonding crystals of said first bonding layer are arranged in parallel or intersected with one another.

19. The diamond membrane as claimed in claim 15, wherein the major axes of the bonding crystals of said second bonding layer are arranged in parallel or intersected with one another.
